(19) United States
(12) Patent Application Publication
(10) Pub. No.: US 2008/0120169 A1
(43) Pub. Date: May 22, 2008

(54) Method of evaluating a salesforce and creating tailored training programs

(76) Inventors: Russell Ward, Tunbridge Wells (GB); Lorna Dakers, Tunbridge Wells (GB)

Correspondence Address: UKITLAW.COM, 28, SILLWOOD ROAD, BRIGHTON, BN1-2LE, omitted

(21) Appl. No.: 11/870,431

(22) Filed: Oct. 11, 2007

Related U.S. Application Data
(60) Provisional application No. 60/860,945, filed on Nov. 22, 2006.

(51) Int. Cl. G06Q 10/00; G06F 17/40; G06F 19/00

(52) U.S. Cl. 705/11

(57) ABSTRACT

A method of evaluating a sales team during real-time sales situations and creating a tailored training program for each member of that team taking into account the team member's individual capabilities and weaknesses, while minimizing the member's time out of the sales field and providing a more efficient way to measure success and return on investment. The administrator (10) assigns an observer (14) to complete assessments (26) for the evaluation of the sales team or individual sales person. These assessments are conducted during real-time sales meetings or events and a sales process interview. Once the evaluation is complete, the observer (14) checks in the assessments (26) and begins collaboration (30) with the administrator (10) to add further comments (30). Power Point slides are generated (41) using the information collected from the assessments. These slides are reviewed and amended (43) before delivery of results (48) to client's corporate management (50).

### CROSS-REFERENCE TO RELATED APPLICATION

This application claims the benefit of Provisional Patent Application Ser. No. 60/860,945 filed Nov. 22, 2006.

### FIELD OF THE INVENTION

The present invention relates to a method of evaluating a sales team during real-time sales situations and creating a tailored training program for each member of that team taking into account the team member's individual capabilities and weaknesses, while minimizing the member's time out of the sales field and providing a more efficient way to measure success and return on investment.

### BACKGROUND

Each year companies spend vast amounts of money on training for their sales force. Traditional methods of sales training generally offer a “one size fits all” approach for every company and their sales people. These traditional methods fail to take into account the differences between companies and more importantly, the individuality of each sales person. By presenting the same training program to the entire sales team, traditional methods fail to recognize that each individual member of the sales force has different capabilities and skill gaps.

In addition, it is difficult to measure the impact and effectiveness of the training program on each sales member. Therefore, a company's return on investment for traditional sales training is also hard to quantify.

Traditional sales training methods do not generally evaluate the individual members of the sales team and therefore can not provide feedback to the member, which would allow them to see the relevance of the sales training program. As previously stated, the individuality of each sales member is important. Some may not acknowledge a need for training. Seeing the training as unnecessary, these sales people may not utilize the techniques and information provided during the training program.

When sales training programs are not used by a company's sales force, the company has not only wasted money, but also valuable sales time. One of the most important flaws of traditional training methods is that it flies in the face of the old adage—“time is money.” Traditional training programs tend to be time intensive and require the individuals to attend lengthy seminars and lectures. This approach takes the sales person away from the field where they could be using that time to generate sales and earn commissions. Cutting into their money making time could explain why sales people are reluctant to go to traditional training programs. It is also understandable why they would fail get the most out of that training.

Accordingly, there has been a long felt need in the sales training industry to provide a cost effective, tailored approach that takes into account the individual competencies and skills gaps of each sales person while minimizing the time out of the sales environment.

### SUMMARY OF THE INVENTION

The present invention is a method of evaluating a client company's salesforce and creating tailored training program specific to real competencies and needs for said salesforce while minimizing salespeople's time out of the field.

This method seeks to improve upon traditional training programs by observing the sales team and their members in real-time sales situations with their prospective customers whereby cutting down on time out of the field and allowing for a tailor-made training regimen to be produced in a cost effective manner.

The present invention is a method for evaluating a sales team and each of its individual members in order to identify their strengths and weaknesses with the resulting data from these evaluations being used to create a tailored training program for each individual. The evaluation process begins with a specialist observer being sent to observe a client company's sales people during “critical sales moments.” These are real-time sales meetings, telesales, etc. between a company sales person and their prospects. The observer maintains a discreet profile and never intervenes in the discussion.

Evaluating the sales person during their critical sales moments is especially valuable as the basis for a development plan for each salesperson—his or her personal route to stronger sales performance. It generates a clear plan for each individual, illustrating exactly what they need to do to improve—and therefore earn more money. This has a galvanizing effect on their motivation. Prior art training programs do not objectively evaluate each sales person and therefore only offer generalized training instead of individualized clear objectives for improvement.

Using electronic/digital scorecards, dozens of objective observations are made during the critical minutes of a sales meeting or telephone sales call. Over 170 objective moment by moment observations are noted on the electronic scorecard which document the sales person's behavior, business practice and selling competency in order to pinpoint each sales person's strengths and weaknesses. These electronic/digital scorecards are tailored to match a company's own sales process and the company's specific needs and objectives such as conformity to particular regulations or practice in an industry.

Additionally, confidential two-hour interviews are conducted with each member of the salesforce during the evaluation. These independent interviews produce valuable insights into the way a client company works and create a context for the findings of the critical moment observations. Above all, the interviews pinpoint opportunities for improving sales performance. The interview covers all the factors that influence sales performance including: Company culture, Motivation, Target Market, Competition, Resources, Marketing function, Lead generation, Training and Use of Customer Relationship Management (CRM) systems. This is important in that the “one-size fits all” approach of the prior art training program does not reflect the uniqueness of each client company or the way each individual sales person performs.

The result is a detailed, objective and concise picture of each salesperson's performance in front of a customer. The observation also identifies trends across the team and barriers in the sales process. With the help of statistical weighting, the observations generate a detailed quantitative evaluation of each salesperson's abilities. The resulting data automatically generates a proposed training program. The program identifies the individual training elements, which are recommended for each sales person resulting in a tailored development program. The tailored development program consists of generally short, sharp training sessions of two to three hours. Therefore, the training programs will not take the salespeople out of the field for days at a time like standard prior art training programs. This keeps the salespeople stimulated and does not keep them away from their customers.

In addition to the above business model, this business method may be packaged and licensed for a “do it yourself” approach, otherwise known as DIY. A DIY client may purchase the program through direct contact by the corporation's management or the method may be purchased online. The licensing company would then configure the evaluation products and scorecards to the needs of the DIY client. The DIY client would then appoint their own independent observer to complete the evaluation assessments. After the assessments are completed, the administering company uses the gathered data and generates it into usable reports in the form of Power Point slides. This gives the DIY clients the information needed to tailor their own training program. In the alternative, the DIY client may contract with the administering company for customized training. This saves time and money for the client by not wasting an employee's valuable time on training that may not be needed. This tailored approach also gets the employee's attention as to what strengths and weaknesses will be addressed. Therefore, the employee will not treat the training time as a holiday off from work.

During the evaluation stages, emailing a questionnaire to the salesperson utilizes another time saving measure. The sales person may complete the questionnaire in private on his own time. The salesperson may be more candid and forthcoming with his responses than if he has to answer the questions for the observer. This is occasionally used in place of or in addition to the interview. The questions are generally grouped into separate sections such as skills, business function barriers, and personality for example. An example question is: On a scale from 1 to 10 (10 being most positive), how good is the internal communication of the company?

The distinguishing characteristics of the present invention over the prior art is in the series of carefully designed objective performance metrics which are evaluated by an independent external observer which in turn allows trustworthy performance mapping. However, the prior art has no objective measures and usually no independent external expert assessor hence not objective and therefore far less reliable.

In addition, this method of evaluating and customizing training programs is not limited to a sales environment. It can easily be modified for other needs such as evaluation and tailored training programs for other types of employees or professionals.

### ADDITIONAL INFORMATION

The following questions are a representative sample of the type answered by the observer during the critical moment observations:

### Did the rep show they had an understanding of the competitors' offerings?

### Were they aware of the strengths and weaknesses of competitors?

### Did the rep demonstrate knowledge of the company's products/services?

### Did they understand the product fit with the client's needs?

### Did they discuss time-scales?

### Is the rep listening to the client?

### Did they sell in the benefits to meet their needs at this point?

### Did they keep quiet after asking for the order?

### If the client tried to put them off did they revisit the sale (i.e. benefits etc)?

### Did they talk about value and comparisons when faced with objections?

### Was the client comfortable with the style of negotiation?

The following questions are a representative sample of the type asked by the observer during the interview:

### Do you have a champion in the company?

### Do you know what percentage of your meetings are relationship nurturing?

### Do you know what percentage of your meetings are closes?

### Do you know how to do a cost benefit analysis?

### Do you know the total budget of your client?

### Have you calculated the potential value of each client to your company?

### Do you allocate your time according to the value calculation?

### Do you know how many clients you can manage at one time?

### Do you know how many clients waste your time?

### BRIEF DESCRIPTION OF THE DRAWINGS

FIG. 1 is a flowchart depicting the business process of a consultative evaluation for a client

FIG. 2 is a flowchart depicting the business process of client performing their own evaluation.

FIG. 3 is a flowchart depicting the business process of online purchase and use of evaluation program.

FIG. 4 is a web chart depicting an example of actual performance versus what the sales person thinks of their own ability.

FIG. 5 represents a timeline for the evaluation stage key activities and timings.

FIG. 6 represents a timeline for the skills development stage key activities and timings.

### DETAILED DESCRIPTION OF THE DRAWINGS

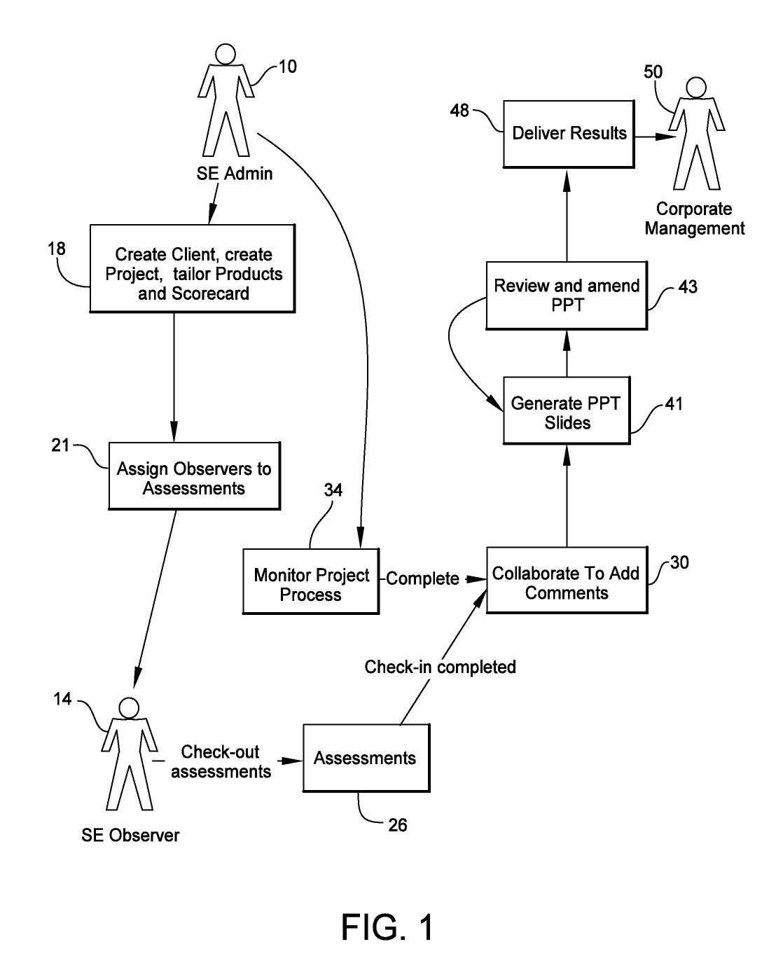

A consultative evaluation for a client company, as shown in FIG. 1, begins with an Administrator (10). The administrator (10) creates a new client set-up on the server (18). During the client set-up a project is created and electronic scorecards and products are tailored to the requirements of the client. Assessments are created during this process. The administrator (10) continues to monitor the progress of the project (34) until the assessments are completed and checked back into the system.

The administrator (10) assigns an observer (14) to check out and complete assessments (26) for the evaluation of the sales team or individual sales person. These assessments are conducted during real-time sales meetings or events and a sales process interview. The observations are recorded in real time on a tablet PC or laptop.

The observer (14) will discreetly observe the sales person during two real-time sales meetings or telephone sales calls and note his observations of the moment by moment behavior, business practice and selling competency on the electronic scorecards.

In the sales process interview, the observer (14) asks the sales person a number of key qualitative and quantitative questions. The answers are recorded and commented on by the observer (14) for later analysis.

Once the evaluation is complete the observer (14) checks in the assessments (26) and begins collaboration (30) with the administrator (10) to add further comments (30). Power Point slides are generated (41) using the information collected from the assessments. These slides are reviewed and amended (43) before delivery of results (48) to client's corporate management (50).

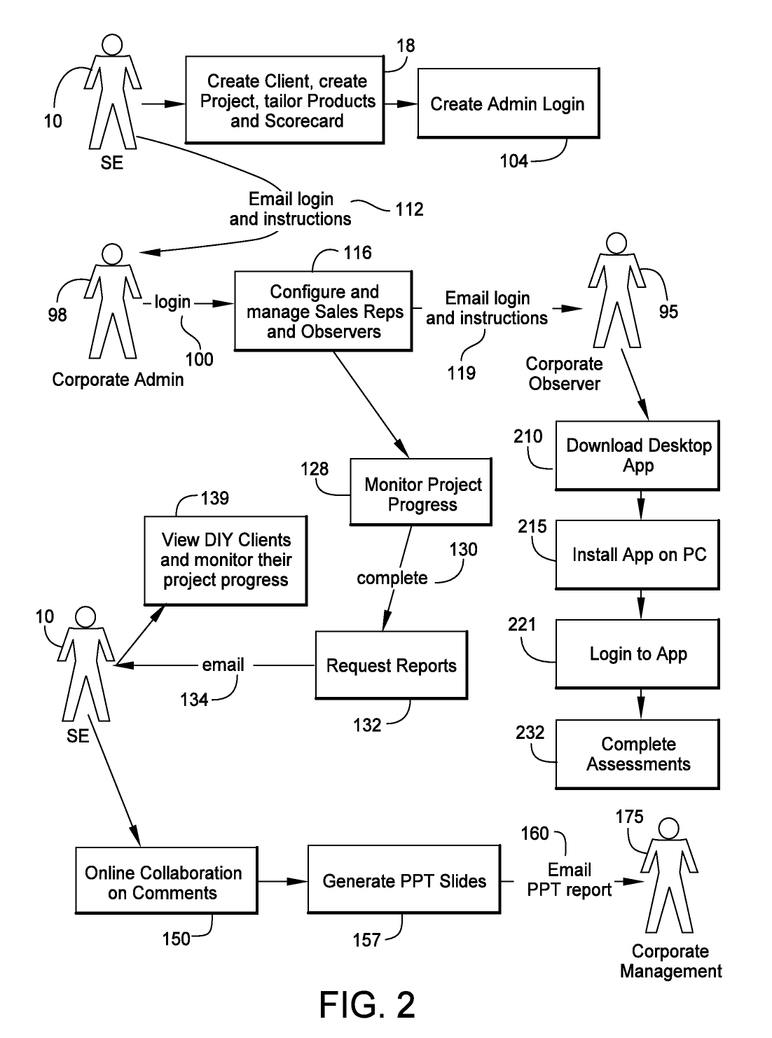

A corporate “do it yourself” (DIY) evaluation model, as shown in FIG. 2, begins with a purchase of the DIY program by a corporation from the administrator (10). The administrator (10) creates a new client set-up on the server (18). During the client set-up a project is created and electronic scorecards and products are tailored to the requirements of the client (18). Assessments are created during this process (18). The administrator (10) monitors the progress of the DIY clients and their project (34). The administrator also creates login details for the corporate administrator (98), which are then emailed to the corporate administrator along with instructions (112).

The corporate administrator (98) logs into the server in order to configure and manage the sales people and observers (116). The corporate administrator (98) then emails the login details and instructions (119) to the corporate observer (95). The observer downloads the desktop application (210) and installs it on a personal computer (215). The observer then logs in to the application (221) and completes the assessments (232) during the evaluation of each sales person.

The corporate administrator (98) continues to monitor the project progress (128) until completion of the evaluations (130). At this time the corporate administrator (98) emails the evaluation assessments (130) and a request for reports (132) of the results to the administrator (10). The administrator (10) hosts an online collaboration (150) on the comments and then generates power point slides (157). These slides are emailed in a report (160) to the corporate management (175).

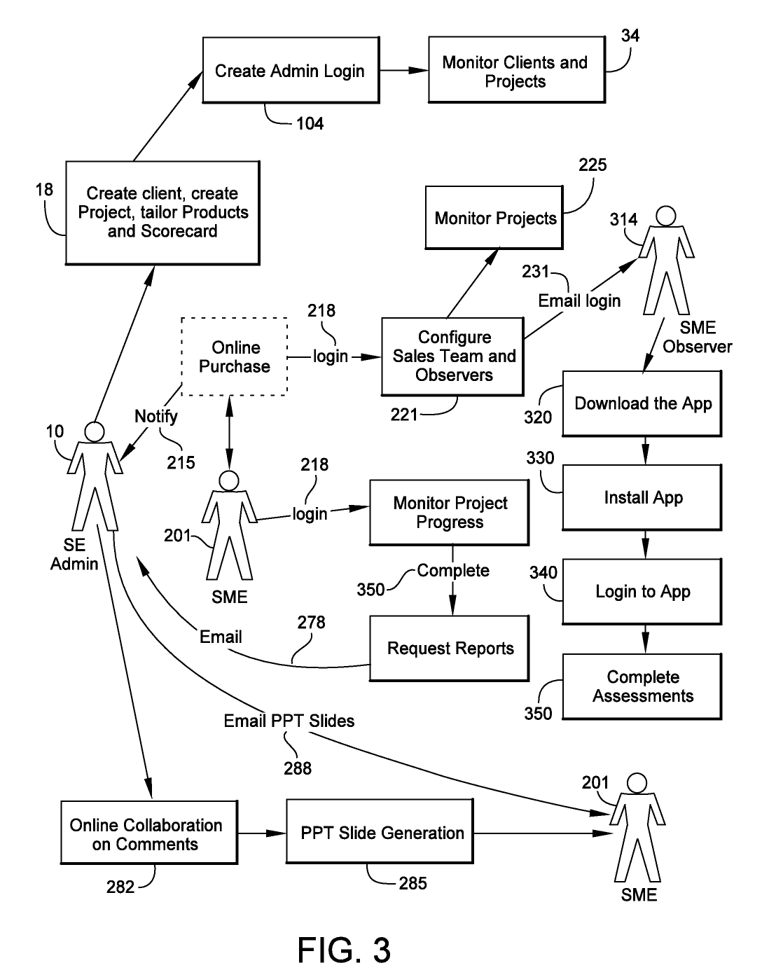

In FIG. 3, another DIY model is shown. This begins with an online purchase (210) by a sales management executive (201), for example. The administrator (10) is first notified of the online purchase (215). Next, the administrator (10) creates a new client set-up on the server (18). During the client set-up a project is created and electronic scorecards and products are tailored to the requirements of the client. Assessments are created during this process. The administrator (10) creates an admin login and monitors the progress of the DIY clients and their project (34).

The DIY client (201) creates his own login information (218) during the online purchase (210). After the administrator (10) has finished customizing the project to the purchaser's requirements, the DIY client (201) can login to configure the sales team and observer information (221). The DIY client will be able to continue to monitor the project progress by using his login (225).

The DIY client emails an observer (314) the login information with instructions on how to proceed with the evaluation (231). The observer (314) downloads the desktop application (320) and installs it on a personal computer (330). The observer (314) then logs in to the application (340) and completes the assessments (350) during the evaluation of each sales person.

Upon completion of the assessments (350), the DIY client (201) emails a request (278) to the administrator (10) for reports on the results of the evaluations. The administrator (10) hosts an online collaboration on the comments (282) then generates the results in a Power Point presentation (285) which are emailed back (288) to the DIY client (201).

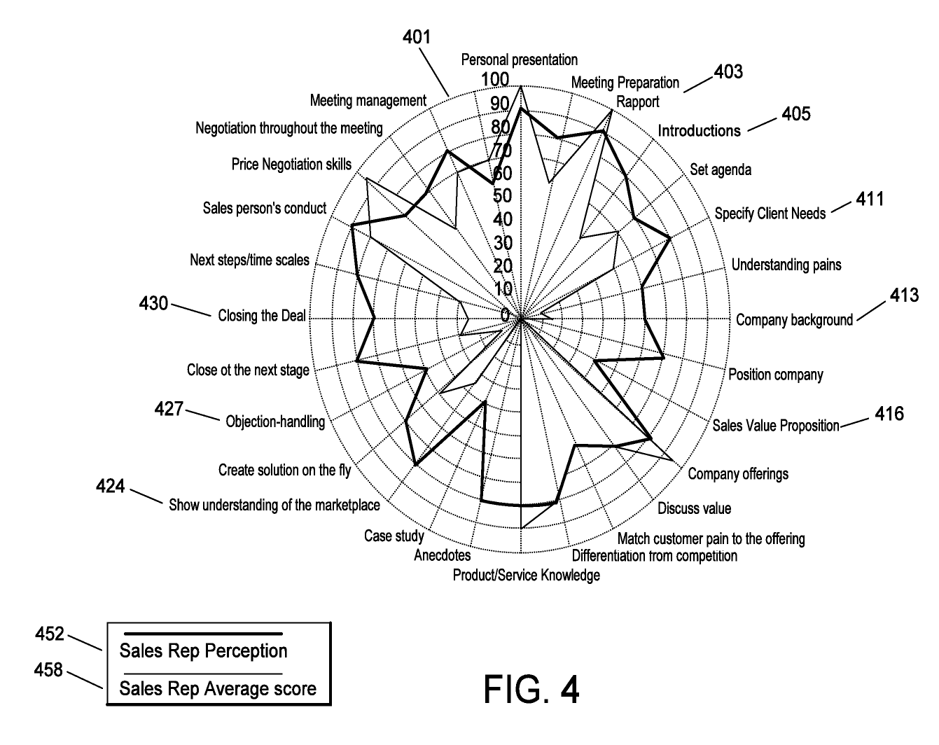

The evaluations create a precise portrait of a sales person's strengths and weaknesses. One type of result graph, shown in FIG. 4, illustrates the difference in the sales person's perceived abilities and his actual selling abilities. The graph maps out these differences on a circular chart (401) with values ranging from 0 to 100. The numerical values correspond to concentric circles with the highest value on the outer edge and the lowest possible value at the center of the circle.

The sales person has been asked to fill out a questionnaire via email in which he rates his own abilities on several important criteria. Some examples of the measured criteria may include: meeting preparation (403), introductions (405), identifying client needs (411), company background (413), sales value propositions (416), showing an understanding of the market place (424), objection handling (427), and closing the deal (430). These criteria are labeled around the edges of the circular graph. Points are then plotted on the concentric circles according to the sales person's answers (452). After the evaluation by the observer, a second set of points is plotted which represent the sales person's actual abilities (458). This graph is visually demonstrates the strengths and weaknesses to the sales person thus helping the sales person to understand which areas need more training in order to achieve better productivity.

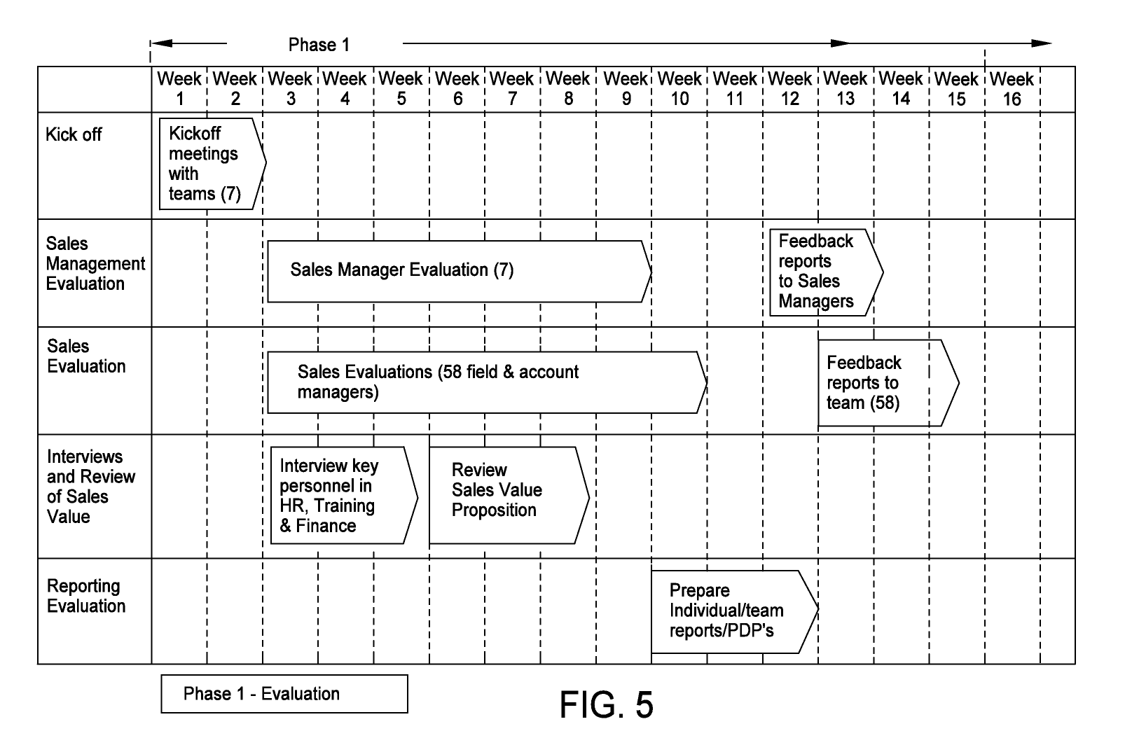

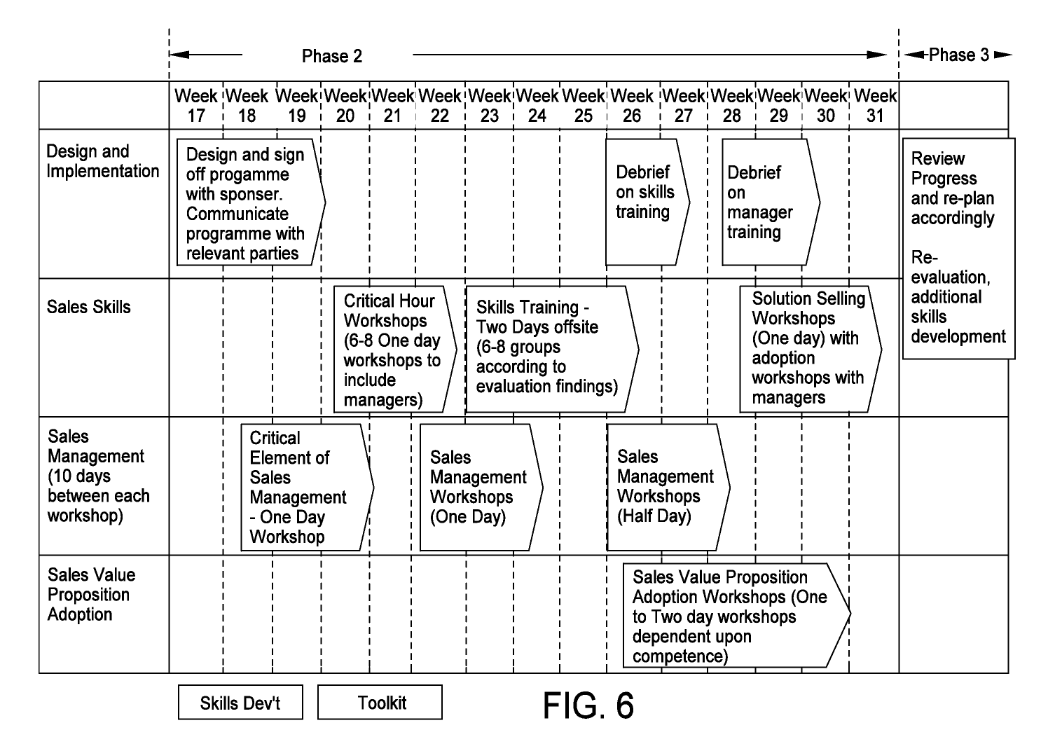

FIGS. 5 and 6 represent timelines for each phase of the evaluation and training. Each timeline lists the individual tasks and the amount of time estimated to complete each task. Other notations may be included within the task bars to indicate important items such as how many sales managers need to be evaluated and how many reports will need to be generated.

### CONCLUSIONS, RAMIFICATIONS AND SCOPE

As will be clear to those of skill in the art, the present invention is suitable for use as a method of evaluating a sales team during real-time sales situations and creating a tailored training program for each member of that team taking into account the team member's individual capabilities and weaknesses, while minimizing the member's time out of the sales field, thus providing a more efficient way to measure success and return on investment.

Although the detailed descriptions above contain many specifics, these should not be construed as limiting the scope of the invention but as merely providing illustrations of some of the presently preferred embodiments of this invention. Various other embodiments and ramifications are possible within its scope, a number of which are discussed in general terms above.

While the invention has been described with a certain degree of particularity, it should be recognized that elements thereof might be altered by persons skilled in the art without departing from the spirit and scope of the invention. Accordingly, the present invention is not intended to be limited to the specific forms set forth herein, but on the contrary, it is intended to cover such alternatives, modifications and equivalents as can be reasonably included within the scope of the invention. The invention is limited only by the following claims and their equivalents.

We claim:

1) A method of evaluating a sales team and each of its individual members and creating a tailored training program for each individual member comprising:
a) sending a specialist observer to observe an individual member of a sales team;
b) observing said individual member during real-time sales events;
c) recording observations made about said individual member on a recording means;
d) conducting a confidential interview with said individual member by said observer;
e) collaborating with an administrator to review and evaluate recorded observations and answers given by said individual member;
f) generating an evaluation report;
g) creating a training program tailored for each individual member of said sales team; and
h) delivering results and recommendations for implementation.

2) The method of evaluating members of a sales team of claim 1 further comprising:
observing said individual member during two real-time sales events and recording these observations in real-time on said recording means.

3) The method of evaluating members of a sales team of claim 1 wherein:
during the step of conducting the confidential interview, a series of key quantitative and qualitative questions are asked by the observer, and answers to said questions are recorded and commented on by the observer for later analysis.

4) The method of evaluating members of a sales team of claim 1 wherein:
said recording means is a computer.

5) A method of evaluating a sales team and each of its individual members and creating a tailored training program for each individual member comprising:
a) setting up a new client project file on a server by an administrator;
b) tailoring electronic scorecards and products specific to requirements of a client;
c) assigning an observer to discreetly observe each member in said client's sales team;
d) checking out and completing assessments of said sales team using said electronic scorecards and products by said observer;
e) conducting a confidential interview with each member by said observer;
f) checking in said assessments upon completion of evaluation;
g) collaborating with said administrator to review and generate results of said assessments;
h) creating a tailored training program for each individual member; and
i) delivering results and recommendations to said company official for implementation.

6) The method of evaluating members of a sales team of claim 4 further comprising:
observing each individual salesperson during two real-time sales events and recording these observations in real-time on said electronic scorecards.

7) The method of evaluating members of a sales team of claim 4 wherein:
during the step of conducting the confidential interview, a series of key quantitative and qualitative questions are asked by the observer, and answers to said questions are recorded and commented on by the observer for later analysis.

8) The method of evaluating members of a sales team of claim 4 wherein:
results of said assessments are generated using a computerized presentation program.

9) A method of evaluating a sales team and each of its individual members and creating a tailored training program for each individual member comprising:
a) purchasing a self-service evaluation program by a company official;
b) setting up a new client project file on a server by an administrator;
c) tailoring electronic scorecards and products specific to requirements of said client;
d) creating access details to said server for use by said company official;
e) observing said individual member in sales team;
f) checking out and completing assessments of said sales team using said electronic scorecards and products by said company official;
g) monitoring of progress by said administrator;
h) conducting a confidential interview with each member by said company official;
i) checking in said assessments upon completion of evaluation;
j) collaborating with said administrator to review and generate results of said assessments;
k) creating a tailored training program for each individual member; and
l) delivering results and recommendations to said company official for implementation.

10) The method of evaluating members of a sales team of claim 9 wherein:
emailing a confidential questionnaire to said individual member may occur in place of conducting a confidential interview, whereby allowing said individual to complete said questionnaire on his own time in private.

11) The method of evaluating members of a sales team of claim 9 further comprising:
observing said individual member during two real-time sales events and recording these observations in real-time on said electronic scorecards.

12) The method of evaluating members of a sales team of claim 9 wherein:
purchasing the self-service evaluation program may be completed over the internet.

13) The method of evaluating members of a sales team of claim 9 wherein:
collaborating with said administrator may be performed entirely online over the internet.

14) The method of evaluating members of a sales team of claim 9 further comprising:
downloading and installing a desktop application by said company official to use for logging in to said server in order to complete said assessments.

15) The method of evaluating members of a sales team of claim 9 wherein:
generating results of said assessments are performed using a computerized presentation program.
